(19) United States
(12) Patent Application Publication
(10) Pub. No.: US 2012/0100900 A1
(43) Pub. Date: Apr. 26, 2012

(54) Method for operating a mobile device to control a main Unit in playing a video game

(75) Inventors: Chen-Wei Su, Taipei City (TW); Chun-Ping Fang, Taipei City (TW); Min-Ching Wu, Taipei City (TW)

(73) Assignee: AIBELIVE CO., LTD, Taipei City (TW)

(21) Appl. No.: 12/926,015

(22) Filed: Oct. 21, 2010

(51) Int. Cl. A63F 13/00

(52) U.S. Cl. 463/8; 463/39; 463/7

(57) ABSTRACT

A method for operating a mobile device to control a main unit in playing a video game by boosting a predetermined execute program in the main unit and starting up the mobile device for enabling the main unit to search the mobile device and to make a wireless connection so that the user can give an instruction to the main unit through the mobile device by hand gesture, voice or touch control, controlling the main unit to run the boosted game program and to display the video subject to communication between a wireless transmission module of the mobile device and a wireless transmitter and receiver module of the main unit and a recognition step by comparing the inputted signal to multiple 3D space hand gesture signal data in a database by a processing unit of the main unit.

### BACKGROUND OF THE INVENTION

1. Field of the Invention

The present invention relates to video game technology and more particularly, to a method for operating a mobile device to control a main unit in playing a video game by means of inputting instruction into the mobile device by hand gesture, voice or touch control for controlling the main unit to run a game program wirelessly, wherein the main unit has stored in a database thereof multiple 3D space hand gesture signal data for the matching of every input signal to improve input accuracy.

2. Description of the Related Art

Following the step of the development of technology and electronic industry, many advanced electronic and electrical products have been created, and have appeared on the market. Except electric and electronic home appliances, computer is one of the most popularly used advanced products. In addition to word processing and computing functions, computer is practical for playing electronic games and on-line games. Further, many different interactive entertainment computers or game consoles are created for use with a display device, television or monitor for playing video games. A computer-based or game console-based game system may use a keyboard, mouse, joystick or remote controller for operation control. However, the limited function of keyboard, mouse, joystick or remote controller cannot satisfy different game operation requirements. Nowadays, many different game grips have been created for controlling a computer or game console to play a video game. By means of operating a game grip to transmit a control signal to the computer or game console, the user can control the running of a game program in the computer or game console. When operating the game grip, a corresponding control signal is synchronously transmitted to the computer or game console, controlling the running of the game program in the computer or game console synchronously. In actual practice, this game grip control method still has drawbacks as follows:
1. The simple operating functions of conventional game grips cannot satisfy the need for running different game programs. For running a different game program, a different game grip, such as swing type game grip, joystick type game grip, steering wheel type game grip, game grip for flying control or game grip for shooting control may be necessary. It is expensive to buy many different types of game grips. Further, storing many different types of game grips requires much storage space.
2. Except the function of transmitting the signal of an action in a wireless manner, conventional game grips are not practical for creating and transmitting a voice control signal or touch control signal. In consequence, the application of conventional game grips is limited.
3. When operating a conventional game grip, the game grip keeps transmitting the signal of the motion of the user. Any motion of the user will cause the game grip to transmit a signal to the computer or game console. However, the computer or game console does not perform any recognition step upon receipt of a control signal from the game grip. False signal or signal of an incomplete motion may be produced to interfere with the play of the video game. In order to improve the accuracy of the game control, extra game control devices may be necessary, increasing the cost.

Therefore, it is desirable to provide a measure for controlling the operation of a computer or game console in running a game program that eliminates the drawback of limited application functions of conventional game grips.

### SUMMARY OF THE INVENTION

The present invention has been accomplished under the circumstances in view. It is one object of the present invention to provide a method for operating a mobile device to control a main unit in playing a video game, which enables different transient instructions given by the user by means of hand gesture, voice or touch control to be converted into corresponding control signals for controlling running of a predetermined program built in a main unit after through a signal recognition step.

To achieve this and other objects of the present invention, a method for operating a mobile device to control a main unit in playing a video game is performed by boosting a predetermined execute program that is built in the main unit and starting up mobile device for enabling the main unit to establish a linking to the mobile device. Thereafter, the user can select the game program to be executed by means of the mouse mode or direction buttons or touch panel of the mobile device, enabling the main unit to boost the selected game program and the related 3D hand gesture signal data. By means of the control module, microphone or input unit of the mobile device, the user can input instructions into the mobile device by hand gesture, voice or touch, enabling the inputted instructions to be converted into corresponding control signals and then transmitted by the wireless transmission module of the mobile device to the wireless transmitter and receiver module of the main unit. When a hand gesture control signal (the action of a hand gesture made in a 3D space (x, y, z-axis) within a predetermined time interval is received, it is compared to the multiple 3D space hand gesture signal data in the database of the main unit for recognition. If the received control signal is not matched, the processing unit compares the next control signal for recognition. When a match is obtained, the processing unit of the main unit controls the execution of the corresponding action of the content of the game program, and drives the display screen to display the mode under execution. After the end of the execution of the game program, the operation is ended.

Further, the main unit can be a computer, game console or server, having built therein a booster program or start-up program for starting up a game. Further, the mobile device can be a cell phone, PDA, game grip, joystick or remote controller capable for inputting hand gesture signals, voice signals and touch control signals for controlling running of the program in the main unit.

Further, the mobile device has installed therein a microphone for voice input, a speaker for voice output, and an input unit for touch control signal input. Further, the sensor of the control module of the mobile can be a gravity sensor, acceleration sensor or gyro sensor.

### BRIEF DESCRIPTION OF THE DRAWINGS

FIG. 1 is a system block diagram in accordance with the present invention.

FIG. 2 is an operation flow chart of the present invention (I).

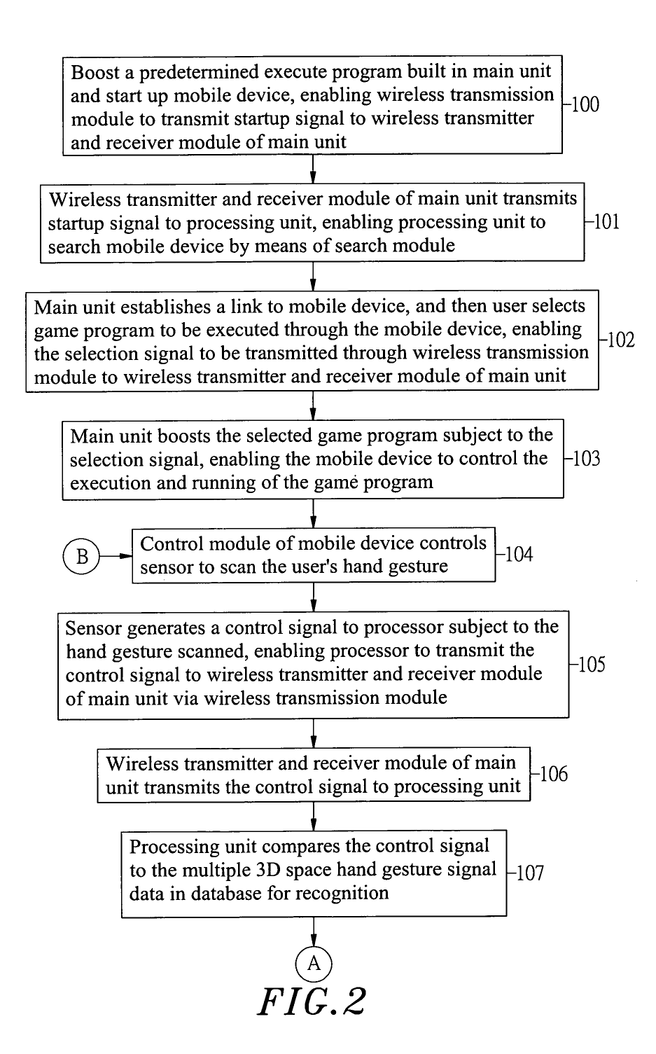

FIG. 3 is an operation flow chart of the present invention (II).

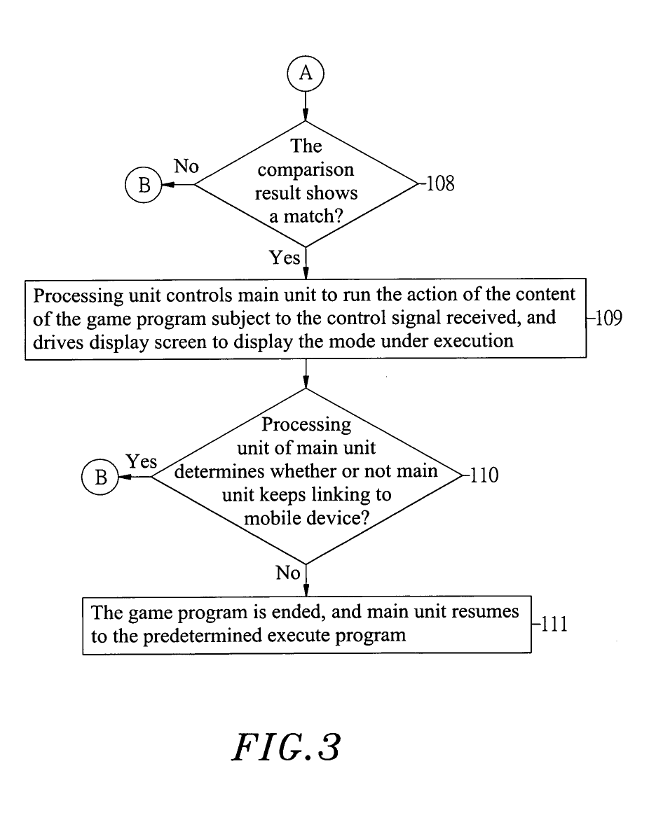

FIG. 4 is a diagram of a 3D dynamic data flow obtained through the sensor of the control module of the mobile device in accordance with the present invention (I).

FIG. 5 is a diagram of a 3D dynamic data flow obtained through the sensor of the control module of the mobile device in accordance with the present invention (II).

### DETAILED DESCRIPTION OF THE PREFERRED EMBODIMENT

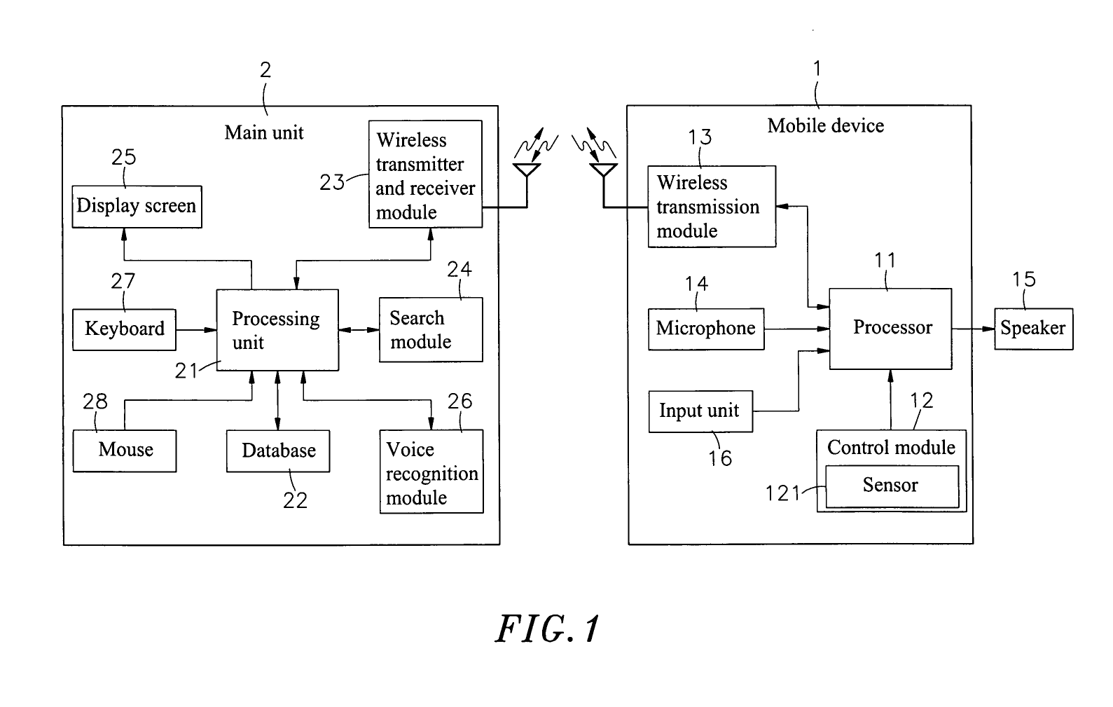

Referring to FIGS. 1˜5, the invention is to be used in a game system comprising a mobile device 1 and a main unit 2.

The mobile device 1 comprises a processor 11, a control module 12, a wireless transmission module 13, a microphone 14, a speaker (or buzzer) 15 and an input unit 16. The control module 12, the wireless transmission module 13, the microphone 14, the speaker 15 and the input unit 16 are respectively electrically connected to the processor 11. Further, the control module 12 includes a sensor 121.

The main unit 2 comprises a processing unit 21, a database 22, a wireless transmitter and receiver module 23, a search module 24, a display screen 25, a voice recognition module 26, a keyboard 27 and a mouse 28. The database 22, the wireless transmitter and receiver module 23, the search module 24, the display screen 25, the voice recognition module 26, the keyboard 27 and the mouse 28 are respectively electrically connected to the processing unit 21. Further, the database 22 has stored therein multiple 3D space hand gesture signal data (X, Y, Z 3-axis data), such as the signal of the motion of a fist blow in a 3D space, the signal of a swing motion in a 3D space, the signal of a push motion in a 3D space, the signal of a circle round motion in a 3D space, the signal of the motion of sliding action in a 3D space, the signal of a jump in a 3D space, or any of a variety of data input signals, including the signal of a clicking action to input an instruction, the signal of a touch control action to input an instruction, the signal of an action in a 3D space inputted by voice, and etc.

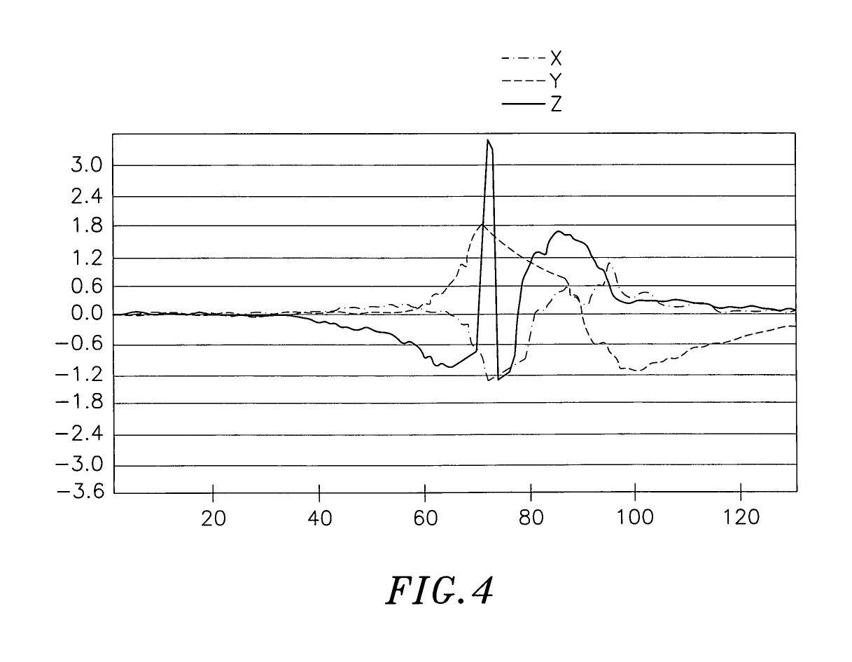

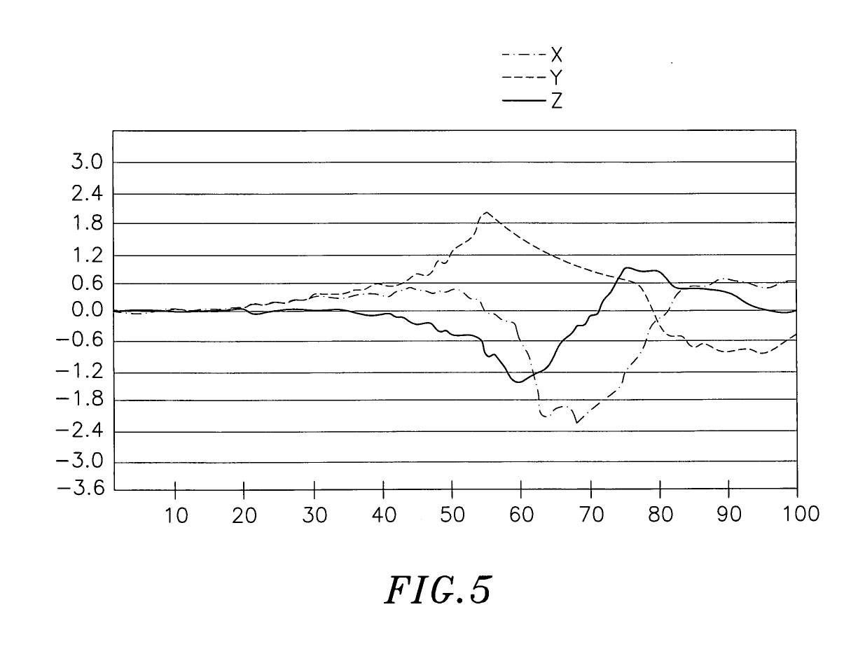

The processor 11 of the mobile device 1 and the processing unit 21 of the main unit 2 can be a CPU, chip or microprocessor that is capable of executing individual program instructions and controlling the operation of other parts. The mobile device 1 can be a cell phone, PDA, game grip, joystick or remote controller for signal input. Further, the sensor 121 of the control module 12 can be a G-sensor, acceleration sensor or gyro sensor, or a combination of an acceleration sensor and a gyro sensor that is capable of sensing the signal of a hand gesture in a 3D space within a time interval (for example, 1 second, 2 seconds or 3 seconds), for example, the 3-axis signal of the motion of a fist blow, swing, push, circle round, slide or jump in a 3D space. In FIGS. 4 and 5, the vertical axis (y-axis) is a variation curve of motion in a 3D space; the transverse axis (x-axis) is the 100 data produced within one unit time (voice signal or touch input signal, such as, signal of clicking action or signal of touch control action).

The control module 12, microphone 14 and input unit 16 of the mobile device 1 are adapted for the input of motion signals, voice signals, or touch control signals. Thus, the mobile device 1 provides multiple application modes for inputting instructions without through any other control devices. Further, the input unit 16 can be a keyboard, joystick or touch panel.

Further, the aforesaid main unit 2 can be a computer, game console or server, having built therein a predetermined execute program (such as booster program or start-up program for starting up a game). The display screen 25 of the aforesaid main unit 2 can be a LCD screen, plasma screen, LED screen or touch screen for A/V signal output.

The predetermined execute program stored in the main unit 2 can be an intelligence game program or sports game program. The intelligence game can be Chinese chess game, Go game, Gobang game, or jumping chess game. The sports game can be boxing game, tennis game, baseball game, basket ball game, volleyball game, sumo game, rowing game, archery game, racing game, high jump game, or broad jump game.

The method for operating the mobile device 1 to control the main unit 2 in playing a video game includes the steps of:
(100) Boost a predetermined execute program that is built in the main unit 2 and start up the mobile device 1, enabling the wireless transmission module 13 to transmit a startup signal to the wireless transmitter and receiver module 23 of the main unit 2.
(101) The wireless transmitter and receiver module 23 of the main unit 2 transmits the startup signal received from the wireless transmission module 13 of the mobile device 1 to the processing unit 21, enabling the processing unit 21 to search the mobile device 1 by means of the search module 24.
(102) The main unit 2 establishes a link to the mobile device 1, and then the user selects the game program to be executed through the mobile device 1, enabling the selection signal to be transmitted through the wireless transmission module 13 to the wireless transmitter and receiver module 23 of the main unit 2.
(103) The main unit 2 boosts the selected game program subject to the selection signal received from the mobile device 1, enabling the mobile device 1 to control the execution and running of the game program
(104) The control module 12 of the mobile device 1 controls the sensor 121 to scan the user's hand gesture (the motion made by the user in a 3D space (x-axis, y-axis, z-axis) within a predetermined time interval).
(105) The sensor 121 of the mobile device 1 generates a control signal to the processor 11 subject to the hand gesture scanned, enabling the processor 11 to transmit the control signal to the wireless transmitter and receiver module 23 of the main unit 2 via the wireless transmission module 13.
(106) The wireless transmitter and receiver module 23 of the main unit 2 transmits the control signal received from the wireless transmission module 13 of the mobile device 1 to the processing unit 21.
(107) The processing unit 21 compares the control signal to the multiple 3D space hand gesture signal data in the database 22 for recognition.
(108) The game system proceeds to step (109) when the comparison result shows a match, or returns to step (104) when no any match is obtained.
(109) The processing unit 21 controls the main unit 2 to run the action of the content of the game program subject to the control signal received, and drives the display screen 24 to display the mode under execution.
(110) The processing unit 21 of the main unit 2 determines whether or not the main unit 2 keeps linking to the mobile device 1, and then the game system returns to step (104) when the main unit 2 keeps linking to the mobile device 1, or proceeds to step (111) when the main unit 2 is disconnected from the mobile device 1.
(111) The game program is ended, and the main unit 2 resumes to the predetermined execute program.

As stated above, the mobile device 1 converts the hand gesture the user made within a predetermined time interval, such as, the motion of fist blow, arrow propelling, shooting displacement, horse riding, boat rowing, jumping, running or walking in a 3D space, the voice instruction (for the action of fist blowing, circling round, swinging, throwing, hitting or jumping) inputted by the user through the microphone 14, or the instruction inputted through the input unit 16 (touch panel, touch switches, handwriting system) into a control signal, and then transmits such a control signal to the wireless transmitter and receiver module 23 of the main unit 2 via the wireless transmission module 13. Upon receipt of the control signal, the wireless transmitter and receiver module 23 of the main unit 2 transmits the control signal to the processing unit 21 for comparing to the multiple 3D space hand gesture signal data in the database 22 for recognition. When a match is obtained, the processing unit 21 executes the corresponding action of the content of the game program subject to the control signal, and drives the display screen 25 to display video. Thus, every operating function of the game program is executed.

Further, a control instruction can be inputted into the processing unit 21 of the main unit 2 by means of the keyboard 27 or the mouse 28 to select the desired execute program (game program or video player software program) for running.

The hand gesture instruction (the motion in a 3D space within a predetermined time interval) inputted into the mobile device 1 must be a complete hand gesture, for example, fist-blowing outward to a certain position, circling round through one turn or a number of turns, swinging to a certain position. Voice instructions (for the motion of fist blowing, circling round, swinging, throwing, hitting or jumping) can be inputted by the user through the microphone 14 into the mobile device 1, or touch-control instructions can be inputted through the input unit 16 (touch panel, touch switches, handwriting system) into the mobile device 1. The mobile device 1 converts each inputted hand gesture instruction, voice instruction or touch-control instruction into a respective control signal that is compared to the multiple 3D space hand gesture signal data in the database 22 by the processing unit 21 for recognition (in case of a voice control signal, it must be recognized by the voice recognition module 26). When matched, the action of the content of the game program is performed subject to the control signal received. When not matched, the false control signal is deleted, avoiding interference with the running of the predetermined program.

It is to be understood that the aforesaid embodiment is simply an example of the present invention but not intended for use as a limitation. According to the method for operating a mobile device to control a main unit in playing a video game in accordance with the present invention, an instruction can be given to the mobile device 1 through the control module 12, the microphone 14 or the input unit 16 by hand gesture, voice or touch. The inputted instruction is converted into a control signal and then transmitted by the wireless transmission module 13 to the wireless transmitter and receiver module 23 of the main unit 2 for comparing to the multiple 3D space hand gesture signal data in the database 22 by the processing unit 21 for recognition so that the processing unit 21 can control the main unit 2 to execute the corresponding action of the content of the game program. Thus, the user can operate the mobile device 1 by hand gesture, voice or touch control to control the running of a predetermined program in the main unit 2 accurately, avoiding errors.

In conclusion, the invention provides a method for operating a mobile device to control a main unit in playing a video game that has the advantages and features as follows:

1. The mobile device 1 has built therein a control module 12, a microphone 14 and an input unit 16 for inputting instructions by hand gesture, voice or touch without through any other control devices. Thus, the mobile device 1 provides multiple application modes, and the user can save much control device cost and control device installation and storage space.

2. By means of using the control module 12 for inputting hand gesture instructions, the microphone 14 for inputting voice instructions and the input unit 16 for inputting touch-control instructions, the mobile device 1 provides multiple input functions, facilitating the use of the system.

3. When a motion or displacement is sensed, the mobile device 1 keeps transmitting the signal to the main unit 2 for comparing to the multiple 3D space hand gesture signal data in the database 22 for recognition. Any incomplete or false hand gesture instruction will not be in match with the multiple 3D space hand gesture signal data in the database 22, and will be rejected. After input of a complete or correct hand gesture instruction, the instruction is converted into a corresponding control signal and transmitted to the main unit 2 for comparing to the multiple 3D space hand gesture signal data in the database 22, and the corresponding action of the content of the game program will be executed only when a match is obtained, avoiding errors.

Therefore, the scope of the invention is the design of signal transmission between a mobile device and a main unit. After input of a complete hand gesture instruction in a 3D space (x, y, z-axis) within a predetermined time interval, the hand gesture instruction is converted into a corresponding control signal and then transmitted by the mobile device to the main unit for comparing to multiple 3D space hand gesture signal data stored in a database for recognition by a processing unit of the main unit. When a match is obtained, a corresponding action of the content of a predetermined game program boosted in the main unit is executed. Further, the mobile device has built therein a control module for inputting hand gesture instructions, a microphone for inputting voice instructions and an input unit for inputting touch-control instructions. Thus, the mobile device provides multiple input functions, facilitating application.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A method for operating a mobile device to control a main unit in playing a video game, said mobile device comprising a processor, a control module, a wireless transmission module, said control module comprising a sensor for sensing the hand gestures of a person, said main unit comprising a processing unit, a database, a wireless transmitter and receiver module, a search module, a display screen, a voice recognition module, a keyboard and a mouse, said database having stored therein multiple 3D space hand gesture signal data (X, Y, Z 3-axis data), the method comprising the steps of:
(a) boosting a predetermined execute program that is built in said main unit and starting up said mobile device to enable said wireless transmission module to transmit a startup signal to said wireless transmitter and receiver module of said main unit;
(b) said wireless transmitter and receiver module of said main unit transmits said startup signal received from said wireless transmission module of said mobile device to said processing unit to enable said processing unit to search said mobile device by means of said search module;
(c) said main unit establishing a link to said mobile device, and then the user selecting a predetermined game program through said mobile device to enable the selection signal to be transmitted through said wireless transmission module to said wireless transmitter and receiver module of said main unit;
(d) said main unit boosting the selected predetermined game program subject to the selection signal received from said mobile device to enable said mobile device to control the execution and running of the game program;
(e) said control module of said mobile device controlling said sensor to scan the user's 3D space X, Y, Z 3-axis hand gesture instruction;
(f) said sensor of said mobile device generating a control signal to said processor subject to the hand gesture instruction scanned to enable said processor to transmit the control signal to said wireless transmitter and receiver module of said main unit via said wireless transmission module;
(g) said wireless transmitter and receiver module of said main unit transmitting the control signal received from said wireless transmission module of said mobile device to said processing unit;
(h) said processing unit comparing the control signal to the multiple 3D space hand gesture signal data in said database for recognition;
(i) the game system of said mobile device and said main unit proceeding to step (j) when the comparison result shows a match, or returning to step (e) when no any match is obtained.
(j) said processing unit controlling said main unit to run the action of the content of the game program subject to the control signal received, and driving said display screen to display the mode under execution;
(k) said processing unit of said main unit determining whether or not said main unit keeps linking to said mobile device, and then the game system returning to step (e) when said main unit keeps linking to said mobile device, or proceeding to step (l) when said main unit is disconnected from said mobile device;
(l) said game program being ended, and said main unit resuming to the predetermined execute program.

2. The method as claimed in claim 1, wherein said main unit is a computer, game console or server; the predetermined execute program built in said main unit is a booster program or start-up program for starting up a game.

3. The method as claimed in claim 1, wherein said predetermined game program is an intelligence game program selected from a group of Chinese chess game, Go game, Gobang game and jumping chess game, or a sports game selected from a group of boxing game, tennis game, baseball game, basket ball game, volleyball game, sumo game, rowing game, archery game, racing game, high jump game and broad jump game.

4. The method as claimed in claim 1, wherein said mobile device is a cell phone, PDA, game grip, joystick or remote controller.

5. The method as claimed in claim 1, wherein said mobile device further comprises a microphone for voice input, a speaker for voice output, and an input unit for touch control signal input.

6. The method as claimed in claim 1, wherein said sensor of said control module of said mobile is one of gravity sensor, acceleration sensor and gyro sensor.

7. The method as claimed in claim 1, wherein said hand gesture instruction according to step (e) and step (f) is the motion made by the user in a 3D space (x-axis, y-axis, z-axis) within a predetermined time interval, a voice signal or a touch-control input signal.

8. The method as claimed in claim 7, wherein the motion made by the user in a 3D space (x-axis, y-axis, z-axis) within a predetermined time interval is a fist blow action, swinging action, pushing action, circling round action, sliding action or jumping action.

9. The method as claimed in claim 7, wherein the touch-control input signal is a signal of a clicking action or touch control action to input an instruction.

10. The method as claimed in claim 1, wherein the multiple 3D space hand gesture signal data in said database according to step (h) and step (i) includes the signal of the motion of a fist blow in a 3D space, the signal of the motion of a swinging action in a 3Dspace, the signal of the motion of a pushing action in a 3D space, the signal of the motion of a circling round action in a 3D space, the signal of the motion of a sliding action in a 3D space, the signal of the motion of a jumping action in a 3D space, the signal of a clicking action to input an instruction, the signal of a touch control action to input an instruction and the signal of an action in a 3D space inputted by voice.
